(19) United States
(12) Patent Application Publication
(10) Pub. No.: US 2022/0358460 A1
(43) Pub. Date: Nov. 10, 2022

(54) DELIVERY PATH GENERATION SYSTEM, DELIVERY PATH GENERATION METHOD, AND NON-TRANSITORY COMPUTER READABLE MEDIUM STORING PROGRAM

(71) Applicant: NEC Platforms, Ltd., Kawasaki-shi, Kanagawa (JP)

(72) Inventor: Akio OISHI, Kanagawa (JP)

(73) Assignee: NEC Platforms, Ltd., Kawasaki-shi, Kanagawa (JP)

(21) Appl. No.: 17/618,600

(22) PCT Filed: Jun. 11, 2020
(86) PCT No.: PCT/JP2020/022965

§ 371 Date: Dec. 13, 2021

(30) Foreign Application Priority Data
Jun. 24, 2019 (JP) 2019-116356

(51) Int. Cl. G06Q 10/08; G06Q 10/04; G01C 21/36

(52) U.S. Cl. CPC G06Q 10/08355; G06Q 10/047; G01C 21/3667; G07C 9/00896

(57) ABSTRACT

A delivery path generation system (20), which generates a delivery path for a delivery terminal to deliver packages to a plurality of destinations, includes destination information acquisition means (11), estimation means (12), and delivery path generation means (13). The destination information acquisition means (11) acquires destination information at least including information based on the behavior of consignees at the respective destinations. The estimation means (12) estimates whether or not the consignee is present based on the destination information. The delivery path generation means (13) generates a delivery path based on the estimation.

### TECHNICAL FIELD

The present disclosure relates to a delivery path generation system, a delivery path generation method, and a program.

### BACKGROUND ART

In recent years, as the electronic commerce market has become more and more active, the frequency of delivery of goods related to commercial transactions has been increasing. On the other hand, when a consignee at a delivery destination is absent in the last mile, which is the last section for delivering a good to a delivery destination, the logistics provider cannot deliver the package and is forced to redeliver it. Therefore, systems for preventing redelivery, which causes a decrease in the efficiency of logistics operations, from increasing, have been proposed.

For example, delivery lockers, which are locker-type facilities that receive goods on behalf of consignees while they are away from home, have become popular. However, as the capacity of these delivery lockers is limited, once they are all occupied, a logistics provider will not be able to deposit goods therein.

In order to solve the above problem, in a delivery locker management system disclosed in Patent Literature 1, a vibration sensor installed in a delivery locker acquires vibration data and detects an event that has occurred in the delivery locker based on the acquired vibration data. Then, the delivery locker management system updates a usage status database that stores the usage status of the delivery locker based on the results of detecting the event.

Further, the at-home check system (Non-Patent Literature 1) automatically calls a delivery destination when a delivery person approaches the delivery destination to inform the consignee of the delivery schedule. The consignee who receives the call answers whether he/she is at home by operating push buttons on the phone.

### CITATION LIST

### Patent Literature

[Patent Literature 1] Japanese Unexamined Patent Application Publication No. 2017-105593

### Non-Patent Literature

[Non-Patent Literature 1] GPS tracker [searched on May 20, 2019], Internet <URL:http://trail.jp/>

### SUMMARY OF INVENTION

### Technical Problem

However, in the technique disclosed in Patent Literature 1, although it is possible to prevent occurrences of redelivery from increasing, when all the delivery lockers are occupied and the consignee is at home, the opportunity to make a delivery may be lost even though it is possible to make a delivery. While it is possible to receive an answer from the consignee in the technique disclosed in Non-Patent Literature 1, it requires a call cost and the consignee needs to respond to the call. Further, it is impossible to know whether or not the consignee is at home unless a delivery person approaches the delivery destination, which may cause the delivery route to be useless.

In view of the above discussion, the aim of the present disclosure is to provide a delivery path generation system and the like that prevent efficiency of a delivery operation from being reduced.

### Solution to Problem

A delivery path generation system according to one example embodiment according to the present disclosure, which is a system for generating a delivery path for a delivery terminal to deliver packages to a plurality of destinations, includes a destination information acquisition unit, an estimation unit, and a delivery path generation unit. The destination information acquisition unit acquires destination information at least including information based on the behavior of consignees at the respective destinations. The estimation unit estimates whether or not the consignee is present based on the destination information. The delivery path generation unit generates a delivery path based on the estimation.

A delivery path generation method according to one example embodiment according to the present disclosure, which is a method for generating a delivery path for a delivery terminal to deliver packages to a plurality of destinations, includes a destination information acquisition step, a presence/absence estimation step, and a delivery path generation step. The destination information acquisition step acquires destination information at least including information based on the behavior of consignees at the respective destinations. The presence/absence estimation step estimates whether or not the consignee is present based on the destination information. The delivery path generation step generates a delivery path based on the estimation.

A delivery management program according to one example embodiment according to the present disclosure is a delivery path generation program for causing a computer to execute a method of generating a delivery path for a delivery terminal to deliver packages to a plurality of destinations. The aforementioned method includes a destination information acquisition step, a presence/absence estimation step, and a delivery path generation step. The destination information acquisition step acquires destination information at least including information based on the behavior of consignees at the respective destinations. The presence/absence estimation step estimates whether or not the consignee is present based on the destination information. The delivery path generation step generates a delivery path based on the estimation.

### Advantageous Effects of Invention

According to the present disclosure, it is possible to provide a delivery path generation system and the like capable of preventing the efficiency of a delivery operation from being reduced.

### BRIEF DESCRIPTION OF DRAWINGS

FIG. 1 is a block diagram of a delivery path generation system according to a first example embodiment;

FIG. 2 is a schematic configuration diagram of a delivery path generation system according to a second example embodiment;

FIG. 3 is a block diagram of a sensor;

FIG. 4 is a block diagram of a gateway device;

FIG. 5 is a block diagram of a server apparatus;

FIG. 6 is a block diagram of a delivery terminal;

FIG. 7 is a sequence diagram showing processing of the sensor, the gateway device, and the server apparatus; and

FIG. 8 is a sequence diagram showing processing of a delivery path generation system.

### DESCRIPTION OF EMBODIMENTS

Hereinafter, the present disclosure will be described based on example embodiments of the present disclosure. However, the disclosure set forth in claims is not limited to the following example embodiments. Moreover, it is not absolutely necessary to provide all the configurations to be described in the following example embodiments as means for solving the problems. For the sake of clarification of the description, the following description and the drawings are partially omitted and simplified as appropriate. Throughout the drawings, the same symbols are attached to the same elements and overlapping descriptions are omitted as necessary.

### First Example Embodiment

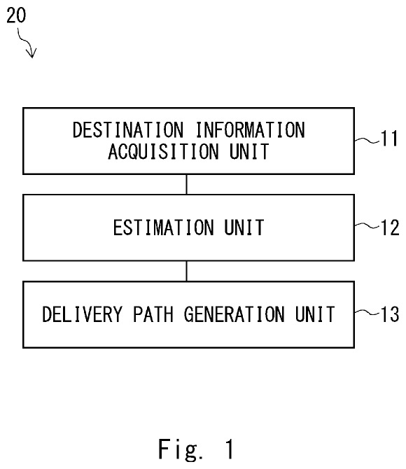

Hereinafter, with reference to FIG. 1, a first example embodiment will be described. FIG. 1 is a block diagram of a delivery path generation system according to the first example embodiment. The delivery path generation system according to the first example embodiment generates a delivery path for a delivery terminal to deliver a package to a destination. A delivery path generation system 20 shown in FIG. 1 includes, as its main components, a destination information acquisition unit 11, an estimation unit 12, and a delivery path generation unit 13.

The destination information acquisition unit 11 is an apparatus for acquiring destination information at least including information based on whether or not a consignee is present at the destination. Upon acquiring the destination information, the destination information acquisition unit 11 supplies the acquired destination information to the estimation unit 12.

The destination information includes, for example, information that is changed in accordance with the behavior of the consignee who is present at the destination to which the delivery terminal is going to deliver the package. The destination information may be, for example, information acquired from a sensor that detects the presence of the consignee. The sensor that detects the presence of the consignee may either be installed in the destination or may be worn by the consignee. Further, the destination information may include, besides the aforementioned information, information such as temperature, humidity, weather, date on the calendar and the like at the destination.

The destination information acquisition unit 11 may be, for example, an interface for acquiring the destination information from the above sensor. Alternatively, the destination information acquisition unit 11 may be an apparatus including the above sensor.

The estimation unit 12 estimates whether or not the consignee is present from the destination information acquired from the destination information acquisition unit 11. The estimation unit 12 is, for example, an information processing apparatus that performs information processing for estimating whether or not the consignee is present. The estimation unit 12 may include an arithmetic apparatus called a Central Processing Unit (CPU) or a Micro Controller Unit (MCU). The estimation unit 12 estimates the presence or the absence by processing the destination information. That is, the estimation unit 12 processes the destination information in accordance with a predetermined method and generates, as results of the processing, a signal indicating the results of the estimation. The estimation unit 12 supplies the generated estimation results to the delivery path generation unit 13.

The delivery path generation unit 13 generates a delivery path from the results of the estimation received from the estimation unit 12. The delivery path is a path for allowing a delivery person to deliver a package to a package destination. For example, the delivery person delivers a plurality of packages deposited by some customers to a plurality of destinations. That is, the delivery person who makes a delivery, moving along with the delivery terminal, delivers the packages in accordance with the delivery path generated by the delivery path generation unit 13.

When, for example, the results of the estimation received from the estimation unit 12 include information which estimates that the consignee at a destination is present, the delivery path generation unit 13 includes this destination in the delivery path. On the other hand, when, for example, the results of the estimation received from the estimation unit 12 include information which estimates that there is no consignee at a destination, the delivery path generation unit 13 does not include this destination in the delivery path. Alternatively, when, for example, the results of the estimation include the hours of the day in which the consignee at the destination is estimated to be at home, the delivery path generation unit 13 generates a delivery path in such a way that the package will be delivered in the hours of the day in which the consignee at the destination is estimated be at home.

The delivery path generation unit 13 presents, for example, the delivery path to the delivery person. The aspect of presenting the delivery path may be, for example, a delivery path along the road used by the delivery person superimposed on a display that displays the map image. The aspect of presenting the delivery path may be, for example, voice, light, or vibrations.

The first example embodiment has been described above. The delivery path generation system 20 according to the first example embodiment may be a single apparatus or it may include separate apparatuses that can communicate with each other.

According to the first example embodiment, it is possible to dynamically update the results of the estimation when the destination information indicating whether or not the consignee is present is acquired and generate a delivery path in accordance therewith. Therefore, the delivery path generation system according to the first example embodiment is able to increase the probability that the delivery person visits the destination in a situation in which the consignee is at home at the destination. In other words, the delivery path generation system 20 according to the first example embodiment is able to prevent the redelivery operation caused by the absence of the consignee. Accordingly, according to the first example embodiment, it is possible to provide a delivery path generation system that prevents efficiency of the delivery operation from being reduced.

### Second Example Embodiment

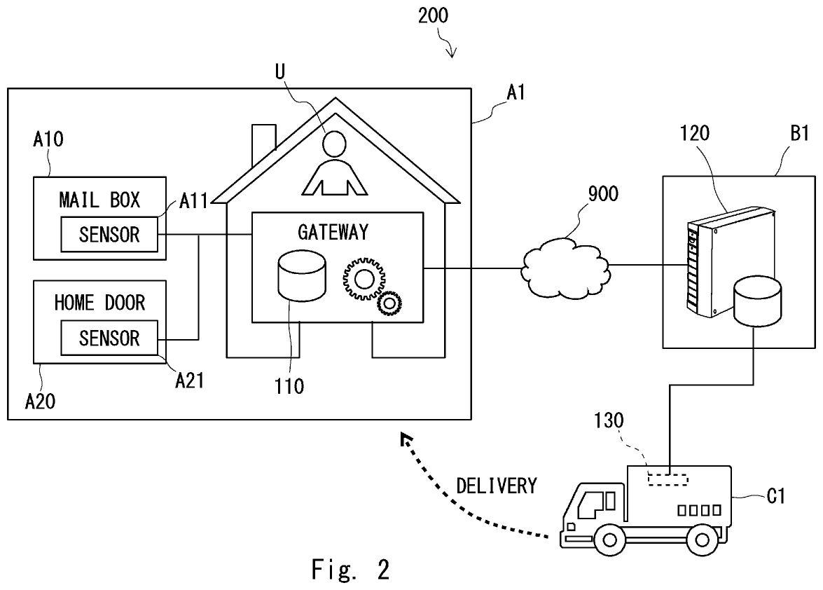

Next, a second example embodiment will be described. FIG. 2 is a schematic configuration diagram of a delivery path generation system according to the second example embodiment. A delivery path generation system 200 according to the second example embodiment includes, as its main components, a home A1 of a consignee U, a delivery company B1, and a delivery truck C1 that delivers a package to the home A1.

The home A1 is a place where the consignee U lives. The home A1 includes a sensor A11 installed in a mail box A10 and includes a sensor A21 installed in a home door A20. Further, a gateway device 110 is installed in the home A1.

The sensor A11 is a sensor that detects the locked state of the mail box A10. The sensor A11 includes a switch that is turned on in a state in which, for example, the mail box A10 is locked and is turned off in a state in which the mail box A10 is unlocked. The sensor A11 is connected to the gateway device 110 and supplies a detection signal regarding the locked state to the gateway device 110.

The sensor A21 is a sensor that detects the opening/closing state of the home door A20. The sensor A21 includes a switch that is turned on when, for example, the home door A20 is opened (opened state) and is turned off when the home door A20 is closed (closed state). The sensor A21, which is connected to the gateway device 110, supplies a detection signal regarding the above locked state to the gateway device 110.

The gateway device 110 receives the detection signals from the sensors A11 and A21 and supplies the received signals to a server apparatus 120 as the destination information at the home A1. The gateway device 110, which is connected to the internet 900, supplies the aforementioned destination information to the delivery company B1 via the internet 900.

The delivery company B1 is a company that takes care of packages from customers and delivers the deposited packages to the designated locations. The delivery company B1 includes the server apparatus 120.

The server apparatus 120 receives the destination information from the gateway device 110 via the internet 900 and estimates whether or not the consignee is present at the home A1 from the received destination information. The server apparatus 120 further generates a delivery path of the delivery truck C1 managed by the delivery company B1 from the results of estimating whether or not the consignee is present. The server apparatus 120 notifies the delivery truck C1 of the information regarding the generated delivery path.

The delivery truck C1 is loaded with a package deposited by the delivery company B1 and the delivery truck C1 delivers the loaded package to the destination. The delivery truck C1 includes a delivery terminal 130. The delivery terminal 130, which is connected to the server apparatus 120 in such a way that the delivery terminal 130 can perform radio communication with the server apparatus 120, receives, for example, information regarding the delivery path from the server apparatus 120.

The schematic configuration of the delivery path generation system 200 according to the second example embodiment has been described above. In FIG. 2, each of the components is shown as single for the sake of facilitating understanding. However, each of these components may be in plural. That is, in the delivery path generation system 200, for example, there may be a plurality of destinations to which the delivery person delivers packages. In this case, the server apparatus 120 may be connected to a plurality of gateway devices 110. Further, in the delivery path generation system 200, there may be a plurality of delivery trucks that deliver packages. In this case, the server apparatus 120 may be connected to a plurality of delivery terminals 130.

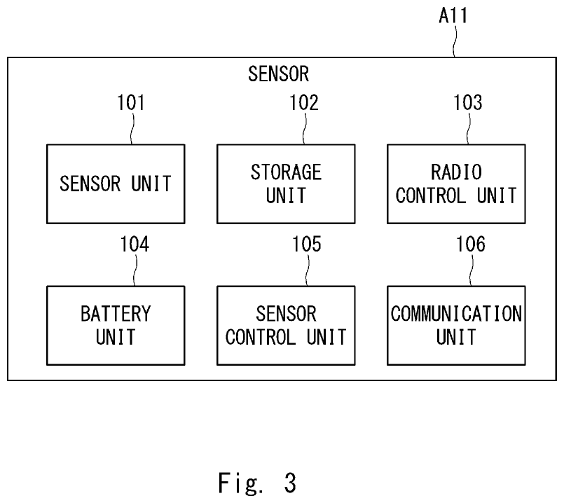

With reference to FIG. 3, a specific aspect of the sensor will be described. FIG. 3 is a block diagram of the sensor A11. The sensor A11 includes, as its main components, a sensor unit 101, a storage unit 102, a radio control unit 103, a battery unit 104, a sensor control unit 105, and a communication unit 116.

The sensor unit 101 detects whether the mail box A10 is locked and generates a signal indicating the results of the detection. The sensor unit 101 is obtained by using, for example, a mechanical switch, a switch using a transmissive or reflective optical sensor, or a switch using Hall elements. The sensor unit 101 supplies the generated signal to the gateway device 110 via the communication unit 106.

The storage unit 102, which is a non-volatile memory such as a flash memory or an Erasable Programmable Read Only Memory (EPROM), stores a program for enabling the sensor control unit 105 or the radio control unit 103 to perform various kinds of control. The storage unit 102 may store a threshold of the locked state detected by the sensor unit 101. In this case, the threshold may be stored in such a way that it can be changed.

The radio control unit 103 controls radio communication that the communication unit 106 performs. The radio control unit 103 may generate, for example, a communication packet for enabling communication in accordance with a predetermined communication system or header and footer information included in the packet.

The battery unit 104 is connected to each component as appropriate and supplies power for driving the sensor A11 to each component.

The sensor control unit 105 controls each component of the sensor A11. The sensor control unit 105 is formed of, for example, a circuit including an MCU. Further, the sensor control unit 105 may include a program stored in the MCU or the storage unit 102.

The communication unit 106 includes an interface that performs radio communication with the gateway device 110 by a predetermined communication system. The communication unit 106 includes, for example, a communication antenna.

While the specific aspect of the sensor A11 has been described above, the configuration of the sensor A11 is not limited to the aforementioned one. The sensor A11 may include all the aforementioned components integrated or may include components that are not integrated and are separated from each other in appearance as long as the aforementioned functions are satisfied. The sensor A21 may include a configuration similar to that of A11 shown in FIG. 3.

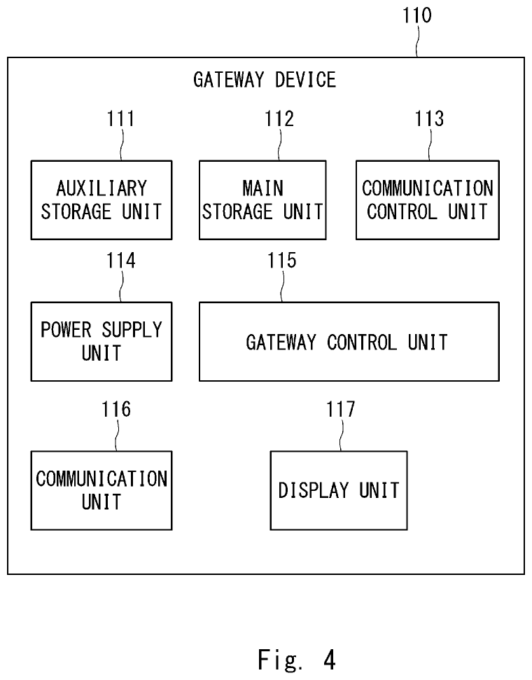

Referring to FIG. 4, details of the gateway device 110 will be described. FIG. 4 is a block diagram of the gateway device 110. The gateway device 110 includes, as its main components, an auxiliary storage unit 111, a main storage unit 112, a communication control unit 113, a power supply unit 114, a gateway control unit 115, a communication unit 116, and a display unit 117.

The auxiliary storage unit 111, which is a non-volatile memory, stores a control program for controlling the gateway device 110. When, for example, the gateway device 110 is started up, the auxiliary storage unit 111 stores the stored control program in the main storage unit 112.

The main storage unit 112, which is, for example, a volatile memory such as a Dynamic Random Access Memory (DRAM) or a Static Random Access Memory (SRAM), is a memory for expanding a control program or the like stored in the auxiliary storage unit 111 and performing reading and/or writing of signals when various kinds of processing are executed. While the main storage unit 112 is preferably formed of a volatile memory whose processing speed is high since high processing speed is preferable in the main storage unit 112, the main storage unit 112 may be formed of a non-volatile memory or may be a combination thereof.

The communication control unit 113 controls communication processing for being connected to the internet 900 via the communication unit 116. Further, the communication control unit 113 controls communication processing for performing communication with the server apparatus 120 via the communication unit 116. The communication control unit 113 performs transmission and/or reception of signals in accordance with a predetermined communication protocol.

The power supply unit 114 is a power supply unit that supplies power for driving the gateway device 110. The power supply unit 114 is connected to, for example, a commercial power supply, receives a predetermined amount of power from the commercial power supply, and supplies the received power to each of the components as appropriate.

The gateway control unit 115 controls each component of the gateway device 110. The gateway control unit 115 is formed of, for example, circuits including a CPU and a program. The gateway control unit 115 receives detection signals from the sensors A11 and A21, executes predetermined processing on the received detection signals, and generates destination information. The gateway control unit 115 may add, for example, time information and information indicating the home A1 to the detection signals acquired from the sensors A11 and A21. Note that the time information and the like may be generated by the sensors A11 and A21. The gateway control unit 115 supplies the generated destination information to the communication control unit 113 or the communication unit 116.

The communication unit 116 is an interface for enabling the gateway device 110 to perform radio communication with the sensors A11 and A21. For example, the communication unit 116 includes an antenna for performing radio communication with the sensors A11 and A21. The communication unit 116 acquires the detection signals from the respective sensors A11 and A21.

The communication unit 116 also serves as an interface for transmitting the destination information to the server apparatus 120 via the internet 900. The communication unit 116 may include, as means for being connected to the server apparatus 120 in such a way that the communication unit 116 communicates with the server apparatus 120, for example, an antenna for performing radio communication or an interface such as a Local Area Network (LAN) connector for achieving wired connection. Upon receiving the destination information from the gateway control unit 115 or the communication control unit 113, the communication unit 116 transmits the received information to the server apparatus 120.

The display unit 117 displays the state of the gateway device 110. The display unit 117 may be, for example, a display device that uses a liquid crystal or an organic EL for performing a predetermined display or may be one or more light-emitting diodes (LEDs) for showing the state of the gateway device 110.

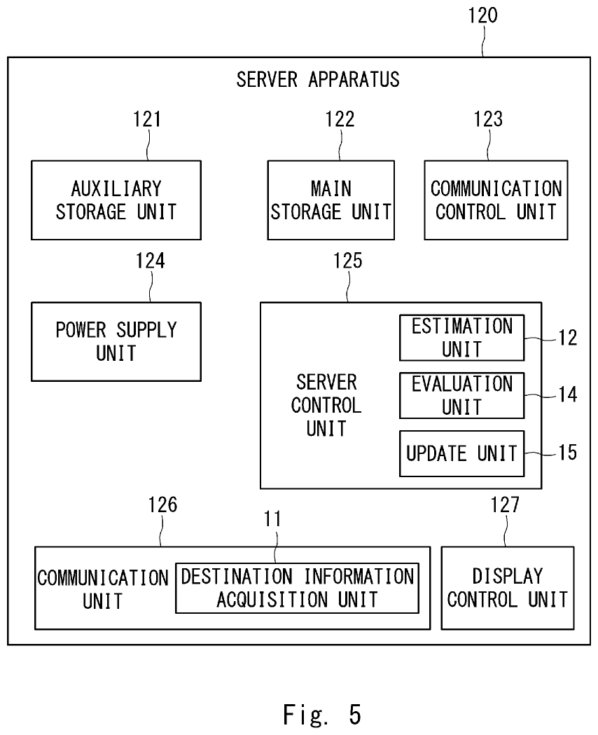

Referring to FIG. 5, details of the server apparatus 120 will be described. FIG. 5 is a block diagram of the server apparatus 120. The server apparatus 120 includes, as its main components, an auxiliary storage unit 121, a main storage unit 122, a communication control unit 123, a power supply unit 124, a server control unit 125, a communication unit 126, and a display control unit 127.

The auxiliary storage unit 121, which is a non-volatile memory, stores a control program for controlling the server apparatus 120. When, for example, the server apparatus 120 is started up, the auxiliary storage unit 121 supplies the stored control program to the main storage unit 122.

The main storage unit 122, which is, for example, a volatile memory such as a DRAM or an SRAM, is a memory for expanding a control program or the like stored in the auxiliary storage unit 121 and performing reading and/or writing when various kinds of processing are executed. The main storage unit 122 may be formed of a non-volatile memory or may be a combination thereof. The main storage unit 122 performs predetermined information processing as it is in conjunction with, for example, the server control unit 125.

The communication control unit 123 controls communication processing for being connected to the internet 900 via the communication unit 126. Further, the communication control unit 123 controls the communication processing for communicating with the delivery truck C1 via the communication unit 126. The communication control unit 123 performs signal transmission/reception in accordance with a predetermined communication protocol.

The power supply unit 124 is a power supply unit for supplying power for driving the server apparatus 120. The power supply unit 124 is connected to, for example, a commercial power supply, receives a predetermined amount of power from the commercial power supply, and supplies the received power to each of the components as appropriate.

The server control unit 125 controls each component of the server apparatus 120 and performs various kinds of information processing. The server control unit 125 is formed of, for example, circuits including a CPU and a program.

The server control unit 125 includes the estimation unit 12 illustrated in the first example embodiment. That is, the server control unit 125 estimates whether or not the consignee is present from the destination information acquired from the gateway device 110. Further, in this example embodiment, the estimation unit 12 analyzes the results of the estimation made by the estimation unit 12 from past destination information and estimates the future presence or absence of the consignee. The estimation regarding the future presence or absence of the consignee is also referred to as at-home prediction data

Hereinafter, specific examples of a case in which the at-home prediction data is generated will be described. The estimation unit 12 extracts, for example, past estimation data for a predetermined period (e.g., one day, one week, one month, or one year). Further, the estimation unit 12 associates the past estimation data with time data such as time, day of the week, date on the calendar, season and the like when the estimation data has been acquired. Then, the estimation unit 12 compares the period of the time data with the estimation data and tries to determine if periodicity can be detected. When periodicity can be detected from the estimation data, the estimation unit 12 associates the estimation data with the time data that corresponds to the estimation data. More specifically, when, for example, it is estimated that the consignee is at home from 8 p.m. to 7 a.m. in one day, the estimation unit 12 estimates, for the at-home prediction data, that the consignee is at home from 8 p.m. to 7 a.m. When, for example, it has been detected that the consignee is at home until 8 a.m. on Mondays, the estimation unit 12 estimates that the consignee is at home until 8 a.m. on Mondays as the at-home prediction data.

The server control unit 125 further includes an evaluation unit 14 and an update unit 15. The evaluation unit 14 receives visit information acquired by the delivery terminal 130 installed in the delivery truck C1 via the server apparatus 120 and estimates the results of the estimation regarding whether or not the consignee is present from the received visit information. The visit information is information indicating whether or not the package was successfully handed over to the consignee as a result of the delivery truck C1 visiting the destination in order to deliver the package. That is, the visit information is information for feeding back whether or not the consignee was actually at home with respect to the results of the estimation made by the estimation unit 12.

The evaluation unit 14 compares, for example, information regarding the result of the estimation made by the estimation unit 12 with the visit information, and when both of these information items indicate “present”, the evaluation unit 14 evaluates that the estimation of the presence or the absence performed from the received destination information has been correct. When, for example, the result of the visit is “absent” although the result of the estimation is “present” as a result of the comparison between the information regarding the result of the estimation made by the estimation unit 12 with the visit information, the evaluation unit 14 evaluates that the estimation of the presence or the absence has not been correct. Specifically, when, for example, the result of the visit has been correct, the evaluation unit 14 performs processing of associating a value indicating that the result has been correct with the result of the estimation. On the other hand, when the result of the visit has not been correct, the evaluation unit 14 performs processing of associating a value indicating that the result has not been correct with the result of the estimation.

The update unit 15 updates the result of the estimation from the destination information acquired by the server control unit 125 and the evaluation performed by the evaluation unit 14. When, for example, it has been estimated that the consignee at the destination is “present” from the destination information and the evaluation unit 14 has evaluated that the result of the estimation has been correct, the update unit 15 maintains the result of the estimation as the update information. On the other hand, when it has been estimated that the consignee at the destination is “present” from the destination information and the evaluation unit 14 has evaluated that the result of the estimation has not been correct, the update unit 15 changes the result of the estimation from “present” to “absent” as the update information.

The update unit 15 may include a function of correcting the algorithm regarding the estimation of the presence or the absence performed by the estimation unit from the destination information acquired in the past and the evaluation information associated with the destination information acquired in the past. The function of correcting the algorithm may be, for example, machine learning that uses the destination information as an input layer and uses the visit information as teacher data.

The communication unit 126 is an interface for allowing the server apparatus 120 to communicate with the gateway device 110 and the delivery truck C1. The communication unit 126 may include, as means for being connected to the gateway device 110 or the delivery truck C1 in such a way that the communication unit 126 is able to communicate with the gateway device 110 or the delivery truck C1, for example, an antenna for performing wireless communication or an interface such as a LAN connector for achieving wired connection. When, for example, the communication unit 126 receives the destination information from the gateway device 110, it supplies the received signal to the communication control unit 123.

The communication unit 126 includes a function of acquiring the destination information including the detection signals detected by the sensors A11 and A21. It can therefore be said that the communication unit 126 includes the destination information acquisition unit 11 described in the first example embodiment. It can further be said that the communication unit 126 is one example aspect of the destination information acquisition unit 11 described in the first example embodiment.

Further, the communication unit 126 supplies the at-home prediction data to the delivery terminal 130 installed in the delivery truck C1. Further, the communication unit 126 receives a signal including visit information from the delivery terminal 130 installed in the delivery truck C1. Upon receiving the signal including the visit information, the communication unit 126 supplies the received signal to the communication control unit 123.

The display control unit 127 performs signal processing and the like for causing a display device (not shown) to display predetermined information. The display control unit 127 may cause the display device to display, for example, the information received from the gateway device 110, or information regarding the state of the home A1 estimated from the destination information or the situation or the like of the delivery truck C1 upon receiving an instruction from the server control unit 125.

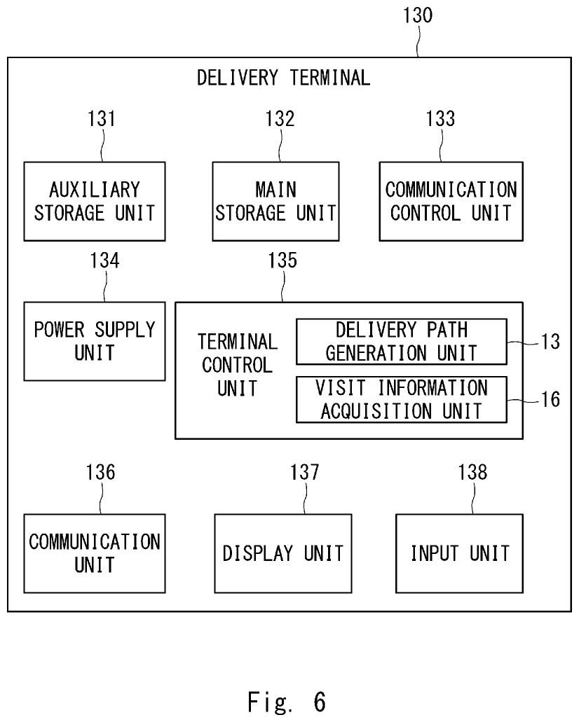

Referring next to FIG. 6, details of the delivery terminal will be described. FIG. 6 is a block diagram of the delivery terminal. The delivery terminal 130 includes, as its main components, an auxiliary storage unit 131, a main storage unit 132, a communication control unit 133, a power supply unit 134, a terminal control unit 135, a communication unit 136, a display unit 137, and an input unit 138.

The auxiliary storage unit 131, which is a non-volatile memory, stores a control program for controlling the delivery terminal 130. When, for example, the delivery terminal 130 is started up, the auxiliary storage unit 131 supplies the control program stored therein to the main storage unit 132.

The main storage unit 132, which is, for example, a volatile memory such as a DRAM or an SRAM, is a memory for expanding a control program or the like stored in the auxiliary storage unit 131 and performing reading and/or writing of signals when various kinds of processing are executed. While the main storage unit 132 is preferably formed of a volatile memory whose processing speed is high as high processing speed is preferable in the main storage unit 132, it may be formed of a non-volatile memory or a combination thereof.

The communication control unit 133 controls communication processing for being connected to the server apparatus 120 via the communication unit 136. The communication control unit 133 performs signal transmission/reception in accordance with a predetermined communication protocol.

The power supply unit 134 is a power supply unit that supplies power for driving the delivery terminal 130. The power supply unit 134 is connected to, for example, a battery of the delivery truck C1, receives a predetermined amount of power from the battery, and supplies the received power to each of the components as appropriate. The power supply unit 134 may include a battery to supply its own power.

The terminal control unit 135 controls each component of the delivery terminal 130. The terminal control unit 135 is formed of, for example, circuits including a CPU and a program. The terminal control unit 135 processes the information received from the server apparatus 120 via the communication unit 136 and causes the display unit 137 to display the results of the processing. Further, the terminal control unit 135 processes a signal received from the input unit 138 to generate predetermined information, and supplies the generated information to the server apparatus 120 via the communication unit 136.

The terminal control unit 135 includes the delivery path generation unit 13 illustrated in the first example embodiment. The delivery path generation unit 13 generates a delivery path from the at-home prediction data received from the server apparatus 120. The terminal control unit 135 causes, for example, the display unit 137 to display the delivery path generated by the delivery path generation unit 13. Accordingly, the delivery person is able to recognize the delivery path and deliver the package in accordance with the delivery path.

The terminal control unit 135 further includes a visit information acquisition unit 16. The visit information acquisition unit 16 acquires the visit information in conjunction with the input unit 138. The visit information is information indicating whether the consignee is present or absent when the delivery truck C1 has visited the destination. The visit information includes, for example, information for identifying the destination that the delivery truck C1 has visited, the date and time when the delivery truck C1 has visited the destination, and whether or not the consignee has been present when the delivery truck C1 has visited the destination. The visit information is generated by, for example, the delivery person who is in the delivery truck C1 operating the input unit 138. After the visit information acquisition unit 16 acquires the visit information, the delivery terminal 130 transmits this information to the server apparatus 120.

The communication unit 136 is an interface for enabling the delivery terminal 130 to perform radio communication with the server apparatus 120. For example, the communication unit 136 includes an antenna for performing radio communication with the server apparatus 120. The communication unit 136 receives the at-home prediction data of the consignee from the server apparatus 120 and supplies the received data to the communication control unit 133. Further, the communication unit 136 receives the visit information acquired by the visit information acquisition unit 16 included in the terminal control unit 135 from the communication control unit 133, and transmits the received visit information to the server apparatus 120.

The display unit 137 is a display device for showing various kinds of information for the delivery person who is in the delivery truck C1. The display unit 137 includes, for example, a display device that uses a liquid crystal or an organic EL for performing predetermined display. The display unit 137 displays, for example, a map of the delivery area regarding the delivery route, and further displays the delivery route superimposed on the map. The display unit 137 may be a part of a navigation system that uses a Global Navigation Satellite System (GNSS).

The input unit 138 is a user interface that accepts an operation by a delivery person and acquires predetermined information in accordance with the accepted operation. The input unit 138 may be, for example, a plurality of switches or buttons or may be a tough panel input device that is superimposed on the display unit 137 and functions in conjunction with the display unit 137. Alternatively, the input unit 138 may be a voice input device including a voice recognition function.

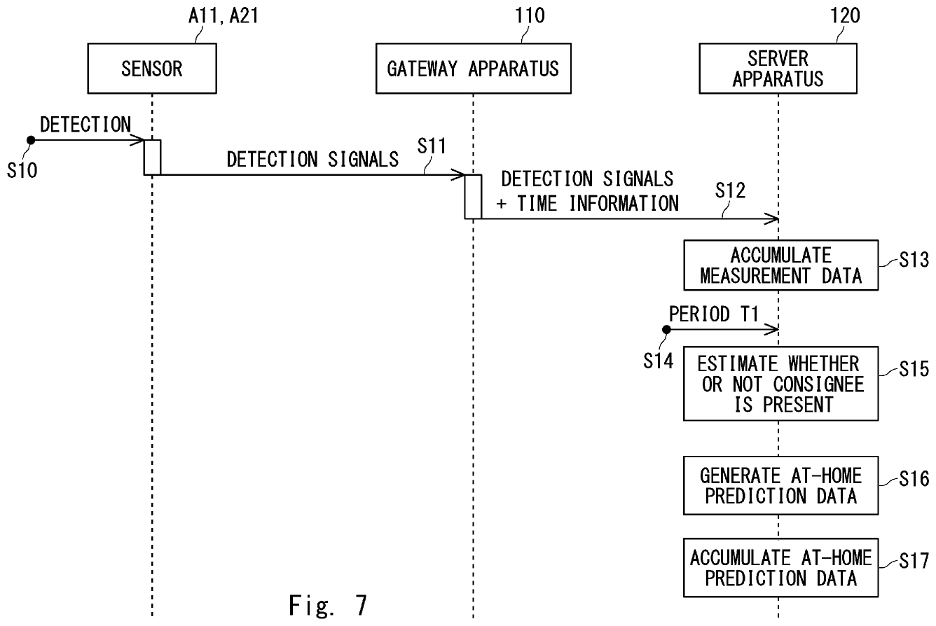

Referring next to FIG. 7, processing between the sensors A11 and A21 and the gateway device 110, and processing between the gateway device 110 and the server apparatus 120 will be described. FIG. 7 is a sequence diagram showing processing of the sensors A11 and A21, the gateway device 110, and the server apparatus 120.

The sensor A11 provided in the mail box A10 and the sensor A21 provided in the home door A20 each perform predetermined detection (Step S10) and then supply the detected signals to the gateway device 110 (Step S11).

Next, upon receiving the detection signals from the sensors A11 and A21, the gateway device 110 performs predetermined processing on the received detection signals and transmits the resulting signals to the server apparatus as destination information (Step S12). As the predetermined processing, the gateway device 110 may add, for example, time information to the detection signals. Further, the gateway device 110 may add information indicating the home A1 to the detection signal. These pieces of the added information may be included in the header or hooter of the destination information, or may be included in the payload.

Next, the server apparatus 120 accumulates the destination information received from the gateway device 110 in the main storage unit 112 (Step S13). Next, the server apparatus 120 detects a predetermined period T1 (e.g., one hour) (Step S14) and estimates whether or not the consignee is present in accordance with a predetermined algorithm from the accumulated detection signals for each period T1 (Step S15).

Shown below is an example of an algorithm for estimating whether the consignee is present or absent. When, for example, the state of the home A1 set first by the server apparatus 120 is “absent” and the home door A20 has been opened/closed in this “absent” state, the server apparatus 120 estimates that the consignee is “present” at the home A1. Further, when, for example, the server apparatus 120 estimates that the consignee is “present” at the home A1 and the home door A20 is opened/closed in this “present” state, the server apparatus 120 estimates that the consignee is “absent” at the home A1.

Further, when, for example, the mail box A10 has been changed from the locked state to the unlocked state, the server apparatus 120 estimates that the consignee is “present” at the home A1. Further, when the opening/closing of the home door A20 has not been detected within a predetermined period of time (e.g., five minutes) after the mail box A10 has been unlocked, the server apparatus 120 estimates that the consignee is “absent” at the home A1.

Next, the server apparatus 120 performs estimation of the future presence or absence of the consignee. That is, the server apparatus 120 generates the at-home prediction data of the consignee U at the home A1 (Step S16). The at-home prediction data is calculated from the past results of the estimation in accordance with a predetermined algorithm. Next, the server apparatus 120 accumulates the at-home prediction data, which is estimation data regarding the future presence or absence (Step S17).

As described above, the server apparatus 120 estimates whether or not the consignee is present from the destination information acquired from the gateway device 110 and accumulates the estimation, thereby estimating the future presence or absence. Further, the server apparatus 120 accumulates the at-home prediction data in which the future presence or absence is estimated. The at-home prediction data is generated according to the aforementioned method, whereby the delivery path generation system 200 is able to dynamically acquire destination information at least including information based on whether or not the consignee U is present at the home A1 and generate the at-home prediction data. Therefore, when, for example, the destination information has been changed, the estimation unit 12 is able to estimate whether the consignee is present or absent in accordance with this change. Further, accordingly, the server apparatus 120 is able to provide highly-accurate at-home prediction data when, for example, it receives an inquiry from the delivery terminal 130.

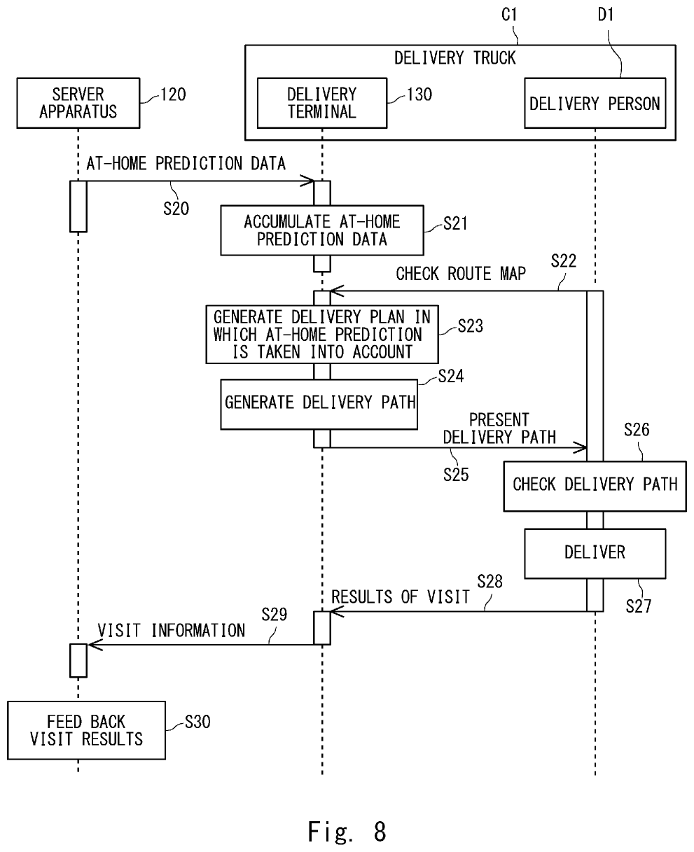

Referring next to FIG. 8, processing in the server apparatus 120 and the delivery terminal 130 will be described. FIG. 8 is a sequence diagram showing the processing in the server apparatus 120, the delivery terminal 130, and the delivery person D1. The delivery person D1 is a delivery person who is in the delivery truck C1.

First, the server apparatus 120 transmits the at-home prediction data to the delivery terminal 130 (Step S20). Next, upon receiving the at-home prediction data from the server apparatus 120, the delivery terminal 130 accumulates the received at-home prediction data (Step S21).

The delivery person D1 gets into the delivery truck C1 and then checks the route information, which indicates the route of the delivery, in order to deliver a package. A case in which the delivery person D1 checks the route information is, for example, a case in which the delivery person D1 checks the daily delivery route information at the start of work on the day of the delivery operation. The delivery person D1 checks the route information by operating the delivery terminal 130 (Step S22).

Next, the delivery terminal 130 that has accepted the operation from the delivery person D1 generates a delivery plan in which the accumulated at-home prediction data is taken into account (Step S23). For example, the delivery terminal 130 extracts, in the delivery plan, a plurality of destinations to which packages are scheduled to be delivered and sets the order of the delivery from the positional information of the respective destinations and the at-home prediction data acquired from the server apparatus 120.

Next, the delivery terminal 130 compares the generated delivery plan with the map information and generates a delivery path (Step S24). The delivery terminal 130 generates a path in accordance with the delivery path when the delivery terminal 130 generates the delivery path. Next, the delivery terminal 130 presents the generated delivery path to the delivery person (Step S25). More specifically, the delivery terminal 130 causes the display unit 137 to display, for example, information in which the map and the delivery path are superimposed on each other and causes the delivery person D1 to recognize the delivery path.

Next, the delivery person D1 checks the delivery path by recognizing the presented delivery path (Step S26). After checking the delivery path, the delivery person D1 gets into the delivery truck C1 and makes a delivery to each destination in accordance with the checked route information (Step S27).

The delivery person D1 who makes a delivery hands over the packages deposited according to the respective destinations at the respective destinations. At this time, the delivery person D1 inputs, as results of visiting the destination, information indicating whether the consignee at the destination has been present or absent into the delivery terminal 130 (Step S28). Upon accepting the input of the visit results, the delivery terminal 130 transmits the visit information, which is information regarding the accepted visit results, to the server apparatus 120 (Step S29).

The server apparatus 120 feeds back the visit results using the visit information received from the delivery terminal 130 (Step S30). Specifically, the server apparatus 120 evaluates, for example, the at-home prediction data using the received visit information. Alternatively, the server apparatus 120 updates, using the received visit information, the estimation of the presence or the absence at the time when it has received the visit information. Alternatively, the server apparatus 120 updates the algorithm for estimating the presence or the absence using the received visit information. When the algorithm for estimating the presence or the absence is updated, the server apparatus 120 may analyze the days of the week or the hours of the day, or both of them regarding which the prediction regarding whether or not the consignee is at home has not been not correct from the past visit results. In this case, the server apparatus 120 may add, for example, an element of time to the algorithm for estimating the presence or the absence for the hours of the day regarding which the prediction regarding whether or not the consignee is at home has not often been correct in the past. The server apparatus 120 may be configured to further add weighting to this time. Accordingly, the delivery path generation system 200 is able to prevent redelivery more correctly.

While the second example embodiment has been described above, the configuration of the delivery path generation system 200 according to the second example embodiment is not limited to the aforementioned configuration. The destination information may include, besides the aforementioned information, information such as temperature, humidity, weather, and date on the calendar at the destination. The mail box A10 may be, for example, a delivery locker in place of the mail box. Further, the delivery terminal 130 may be installed in a bicycle, a motorcycle, a drone, a ship, a walking robot or the like instead of being installed in the delivery truck C1. The delivery person D1 who gets in the delivery truck C1 along with the delivery terminal 130 is not an absolutely necessary component. That is, for example, the delivery truck C1 may be able to autonomously travel and may include means for handing over a package to the consignee U. The gateway device 110 may be connected to the sensors A11 and A21 in such a way that the gateway device 110 can communicate with the sensors A11 and A21 by a line, may be connected to the sensors A11 and A21 in such a way that the gateway device 110 can communicate with the sensors A11 and A21 by radio waves, or may be connected to the sensors A11 and A21 in such a way that the gateway device 110 can communicate with the sensors A11 and A21 by communication means using light. The sensors A11 and A21 may each include a battery, may be supplied with power from the gateway device 110, or may be supplied with power from a commercial power supply.

As described above, according to the second example embodiment, it is possible to improve the efficiency of the delivery operation by preventing the redelivery operation. Accordingly, it is expected that the amount of energy consumed at the time of traveling will be reduced, traffic congestion will be mitigated, and the burden on the delivery person will be reduced. Further, according to the second example embodiment, since it is assumed to make a delivery in a situation in which the consignee is at home, even if the package cannot be put into the delivery locker, the package can be handed over to the consignee, which prevents the redelivery. Further, since the delivery path generation system 200 according to the second example embodiment does not require a telephone call, the consignee does not need to answer the call, which reduces the burden on the consignee.

As described above, in the delivery path generation system 200 according to the second example embodiment, the delivery terminal 130 accumulates the at-home prediction data generated by the server apparatus. Therefore, the delivery terminal 130 that has accumulated the at-home prediction data in advance is able to generate a delivery path with fast responsiveness when it receives a request from the delivery person to check the delivery path. As described above, according to the second example embodiment, it is possible to provide a delivery path generation system that prevents efficiency of the delivery operation from being reduced.

Further, the aforementioned program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The present disclosure is not limited to the above example embodiments and may be changed as appropriate without departing from the spirit of the present disclosure.

While the present disclosure has been described above with reference to the example embodiments, the present disclosure is not limited to the aforementioned example embodiments. Various changes that may be understood by those skilled in the art can be made to the configuration and the details of the present disclosure within the scope of the present disclosure.

This application is based upon and claims the benefit of priority from Japanese Patent Application No. 2019-116356, filed on Jun. 24, 2019, the disclosure of which is incorporated herein in its entirety by reference.

### REFERENCE SIGNS LIST

11 Destination Information Acquisition Unit
12 Estimation Unit
13 Delivery Path Generation Unit
14 Evaluation Unit
15 Update Unit
16 Visit Information Acquisition Unit
20, 200 Delivery Path Generation System
101 Sensor Unit
102 Storage Unit
103 Radio Control Unit
104 Battery Unit
105 Sensor Control Unit
106, 116, 126, 136 Communication Unit
110 Gateway Device
111, 121, 131 Auxiliary Storage Unit
112, 122, 132 Main Storage Unit
113, 123, 133 Communication Control Unit
114, 124, 134 Power Supply Unit
115 Gateway Control Unit
117, 137 Display Unit
120 Server Apparatus
125 Server Control Unit
127 Display Control Unit
130 Delivery Terminal
135 Terminal Control Unit
138 Input Unit
900 Internet
A1 Home
A11, A21 Sensor
A20 Home Door
B1 Delivery Company
C1 Delivery Truck
D1 Delivery Person
U Consignee

What is claimed is:

1. A delivery path generation system for generating a delivery path for a delivery terminal to deliver packages to a plurality of destinations, the delivery path generation system comprising:
destination information acquisition unit configured to acquire destination information at least including information based on the behavior of consignees at the respective destinations;
estimation unit configured to estimate whether or not the consignee is present based on the destination information; and
delivery path generation unit configured to generate the delivery path based on the estimation.

2. The delivery path generation system according to claim 1, wherein the destination information acquisition unit acquires, as the destination information, information regarding the state of equipment installed in the destination.

3. The delivery path generation system according to claim 2, wherein the destination information acquisition unit acquires, as the destination information, information regarding at least one of an opening/closing operation of a doorway of the destination and a state of a key of a package holder.

4. The delivery path generation system according to claim 3, wherein the destination information acquisition unit acquires, as the destination information, at least one of information regarding an opening/closing operation of an entrance door of the destination and information regarding a state of a key of a mail box or a delivery locker of the destination.

5. The delivery path generation system according to claim 1, further comprising:
visit result information acquisition unit configured to acquire visit result information from the delivery terminal that has visited the destination in accordance with the delivery path; and
evaluation unit configured to evaluate the result of the estimation based on the visit result information.

6. The delivery path generation system according to claim 5, further comprising update unit configured to update the result of the estimation based on the destination information and the information on the evaluation.

7. The delivery path generation system according to claim 6, further comprising storage unit configured to store the destination information for a predetermined period and the information on the evaluation for the period, wherein
the update unit updates the result of the estimation based on the destination information and the information on the evaluation for the period, and
the delivery path generation unit generates the delivery path based on the result of the estimation that has been updated.

8. The delivery path generation system according to claim 1, wherein
the delivery terminal includes display unit configured to display a map, and
the display unit displays the delivery path superimposed on the map.

9. A delivery path generation method for generating a delivery path for a delivery terminal to deliver packages to a plurality of destinations, the delivery path generation method comprising:
acquiring destination information at least including information based on the behavior of consignees at the respective destinations;
estimating whether or not the consignee is present based on the destination information; and
generating the delivery path based on the estimation.

10. A non-transitory computer readable medium storing a delivery path generation program for causing a computer to execute a method of generating a delivery path for a delivery terminal to deliver packages to a plurality of destinations, the method comprising:
acquiring destination information at least including information based on the behavior of consignees at the respective destinations;
estimating whether or not the consignee is present based on the destination information; and
generating the delivery path based on the estimation.
